(19) United States
(12) Patent Application Publication
(10) Pub. No.: US 2017/0036471 A1
(43) Pub. Date: Feb. 9, 2017

(54) Printer System

(71) Applicant: Fargo Automation, Inc., Fargo, ND (US)

(72) Inventors: Kevin N. Biffert, Fargo, ND (US); Stephanie M. Meier, Fargo, ND (US)

(73) Assignee: Fargo Automation, Inc.

(21) Appl. No.: 15/230,121

(22) Filed: Aug. 5, 2016

Related U.S. Application Data
(60) Provisional application No. 62/201,381, filed on Aug. 5, 2015.
(60) Provisional application No. 62/239,366, filed on Oct. 9, 2015.

(51) Int. Cl. B41J 29/393

(52) U.S. Cl. CPC B41J 29/393

(57) ABSTRACT

A printer system for printing an image on an object and verifying its accuracy. The printer system generally includes a printer which is adapted to print an image on a printing medium such as a roll of web paper. The image may include product data related to a product being stored in product packaging, such as a machine-readable code. The product data may be printed on a label to be affixed to product packaging, or on the product packaging itself. A reference image is printed on the printing medium and a sensor scans the printed image. By comparing the printed image to the reference image, a computing device may detect defects and distinguish between a defective printed image and a correct printed image.

### CROSS REFERENCE TO RELATED APPLICATIONS

I hereby claim benefit under Title 35, United States Code, Section 119(e) of U.S. provisional patent application Ser. No. 62/239,366 filed Oct. 9, 2015. The application 62/239,366 is currently pending. The application 62/239,366 is hereby incorporated by reference into this application.

I hereby claim benefit under Title 35, United States Code, Section 119(e) of U.S. provisional patent application Ser. No. 62/201,381 filed Aug. 5, 2015. The application 62/201,381 is currently pending. The application 62/201,381 is hereby incorporated by reference into this application.

### STATEMENT REGARDING FEDERALLY SPONSORED RESEARCH OR DEVELOPMENT

Not applicable to this application.

### BACKGROUND

Field

Example embodiments in general relate to a printer system for printing an image on an object and verifying its accuracy.

Related Art

Any discussion of the related art throughout the specification should in no way be considered as an admission that such related art is widely known or forms part of common general knowledge in the field.

Medical devices and pharmaceutical products may be typically packaged in packaging materials for distribution. The packaging materials may include plastic films, foil wrapping, or paper-based packaging materials. In practice, the products are introduced into the packaging material and the packaging material is then sealed to include the product. Conventionally, many devices and methods may be employed to seal the packaging material, such as horizontal form fill seal packaging machines, for example.

A product barcode may be printed directly on the surface of the packaging or, alternatively, may be printed on a label that is affixed to a surface of the packaging. The barcode may indicate the contents of the product. Once each product is labeled with the barcode, the labeled products may be grouped and/or sorted into shipping containers, e.g., boxes, bags, bins, or totes. Typically, an individual will manually inspect the label to verify that the barcode is correct. This approach may be tedious, labor intensive and subject to error.

Therefore, improved systems and methods for packaging medical devices and pharmaceutical products and verifying product labels are desirable.

### SUMMARY

An example embodiment of the present invention is directed to a printer system. The printer system includes a printer which is adapted to print an image on a printing medium such as a web roll. The image may comprise any type of image, such as product data related to a product being stored in product packaging, such as a machine-readable code. The printing medium may comprise a label to be affixed to product packaging, or the product packaging itself. A reference machine-readable code is printed on the printing medium and a sensor scans the printed machine-readable code. By comparing the printed machine-readable code to the reference machine-readable code, the computing device may detect defects and distinguish between a defective machine-readable code and a correct machine-readable code.

A packaging system may generally comprise a conveyor to convey a printing medium; a reader to scan a barcode to generate barcode image data to be labeled on a sealed package; a print module to receive the barcode image data, and to print a barcode based on the barcode image data on the printing medium; an image acquisition module to scan the printed barcode, and generate scanned image data; an image quality analysis module to analyze the scanned image data to identify one or more defects based on the barcode image data; and a sealing module to apply at least one seal to a package thereby forming a sealed package. The system may comprise a labeling module to apply the printed barcode to the sealed package.

A method of sealing packages may generally comprise conveying a printing medium; receiving barcode image data to be applied to a sealed package; printing a barcode based on the barcode image data on the printing medium; scanning the printed barcode on the print medium and acquiring scanned image data; analyzing the scanned image data to identify one or more defects based on the barcode image data; sealing packaging material to form a sealed package; and labeling the sealed package with the printed barcode.

There has thus been outlined, rather broadly, some of the features of the printer system in order that the detailed description thereof may be better understood, and in order that the present contribution to the art may be better appreciated. There are additional features of the printer system that will be described hereinafter and that will form the subject matter of the claims appended hereto. In this respect, before explaining at least one embodiment of the printer system in detail, it is to be understood that the printer system is not limited in its application to the details of construction or to the arrangements of the components set forth in the following description or illustrated in the drawings. The printer system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of an exemplary integrated packaging and printing system which incorporates the methods and systems described herein.

FIG. 2 is a frontal view of a printing module with the print bed in a raised position in accordance with an exemplary embodiment.

FIG. 3 is a frontal view of a printing module with the print bed in a lowered position in accordance with an exemplary embodiment.

FIG. 4 is an upper perspective view of a printing module in accordance with an exemplary embodiment.

FIG. 5 is an upper perspective view of a printing module with the printer housing removed in accordance with an exemplary embodiment.

FIG. 6 is an upper perspective view of a printing medium with a defective image and a correct image printed thereon in accordance with an exemplary embodiment.

FIG. 7 is an exemplary reference sheet for use with an exemplary embodiment.

FIG. 8 is an upper perspective view of product packaging including defective and correct images comprising machine-readable codes printed thereon in accordance with an exemplary embodiment.

FIG. 9 is an upper perspective view of product packaging including defective and correct images comprising product data printed thereon in accordance with an exemplary embodiment.

FIG. 10 is an upper perspective view of product packaging including defective and correct images comprising company logos printed thereon in accordance with an exemplary embodiment.

FIG. 11 is an exemplary block diagram illustrating an exemplary embodiment.

FIG. 12 is a flowchart illustrating an exemplary method of analyzing a scanned and printed image.

FIG. 13 is a flowchart illustrating an exemplary method of scanning a reference image from a reference sheet.

FIG. 14 is a flowchart illustrating an exemplary method of printing an image on a printing medium.

FIG. 15 is a flowchart illustrating an exemplary method of detecting defects in the printed image.

FIG. 16 is a flowchart illustrating an exemplary method of correcting print head alignment.

### DETAILED DESCRIPTION

### A. Overview

An example printer system generally comprises a printer 40 which is adapted to print an image 74, 75 on a printing medium 30 such as a web roll. The image 74, 75 may comprise any type of image, including images having text, symbols, numbers, diagrams, or any combination thereof. By way of example, the image 74, 75 could comprise product data related to a product being stored in product packaging 11, such as a machine-readable code. The printing medium 30 may comprise a label to be affixed to product packaging 11, or the product packaging 11 itself. A reference image 72 is printed on the printing medium 30 and a sensor 50 scans the printed image 74, 75. By comparing the printed image 74, 75 to the reference image 72, the computing device 60 may detect defects and distinguish between a defective printed image 74 and a correct printed image 75.

It should be appreciated that the methods and systems described herein may be utilized to print a variety of different types of images 74, 75 on a variety of different types of objects or printing mediums 30. Although much of the description focuses on the printing of product data such as machine-readable codes, it should be appreciated that any type of image 74, 75 could be printed by the printer 40 and then verified by the computing device 60.

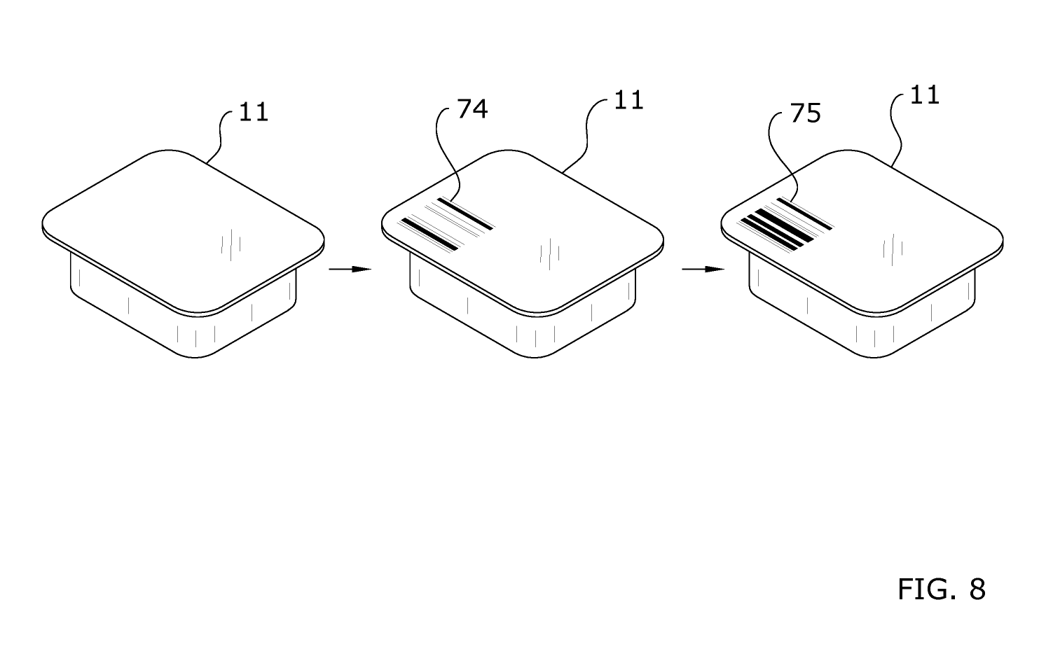

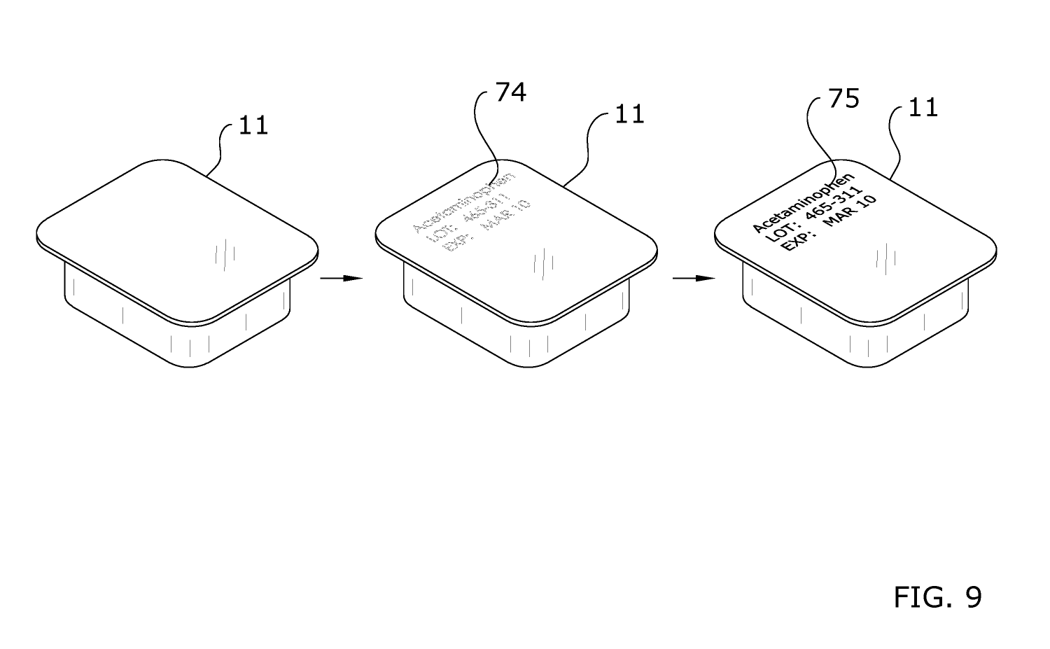

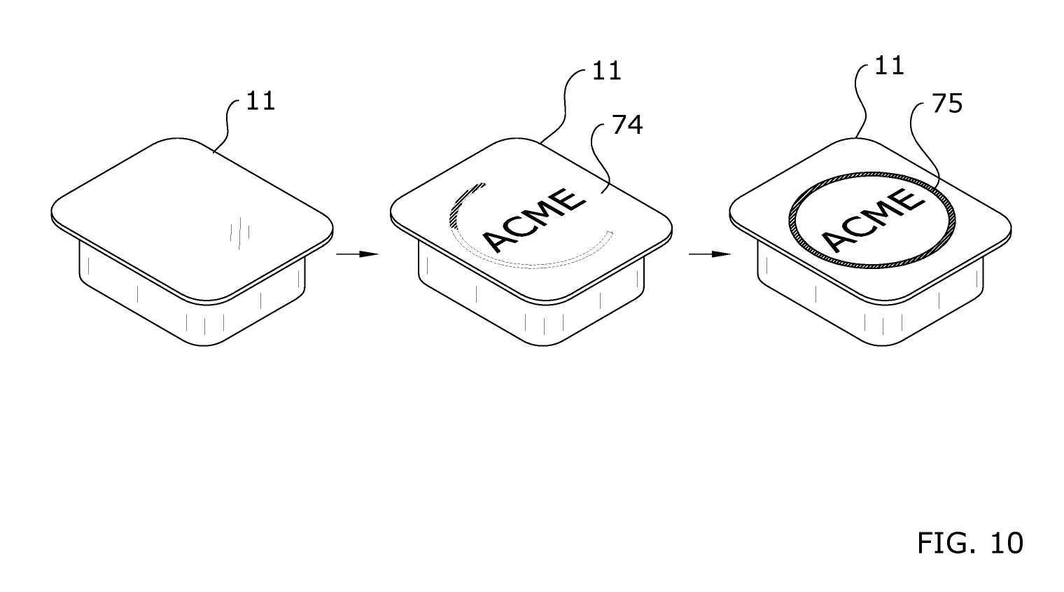

Thus, the present invention should not be construed as limited to printing and verification of product data, although it is well-suited for such functionality. Printed images 74, 75 could comprise pictures, writing, symbols, or the like without any limitation. By way of example, printed images 74, 75 could comprise machine readable medium, including machine readable such as bar codes, quick response (QR) codes, waveforms, numbers, symbols, text, and the like. FIG. 8 illustrates printed images 74, 75 comprising bar codes. FIG. 9 illustrates printed images 74, 75 comprising product data including product name, lot number, and expiration date. Printed images 74, 75 could also comprise labels, graphics, logos, pictures, or the like. FIG. 10 illustrates printed images 74, 75 comprising a company logo on product packaging 11.

### B. Integrated Packaging and Printing System

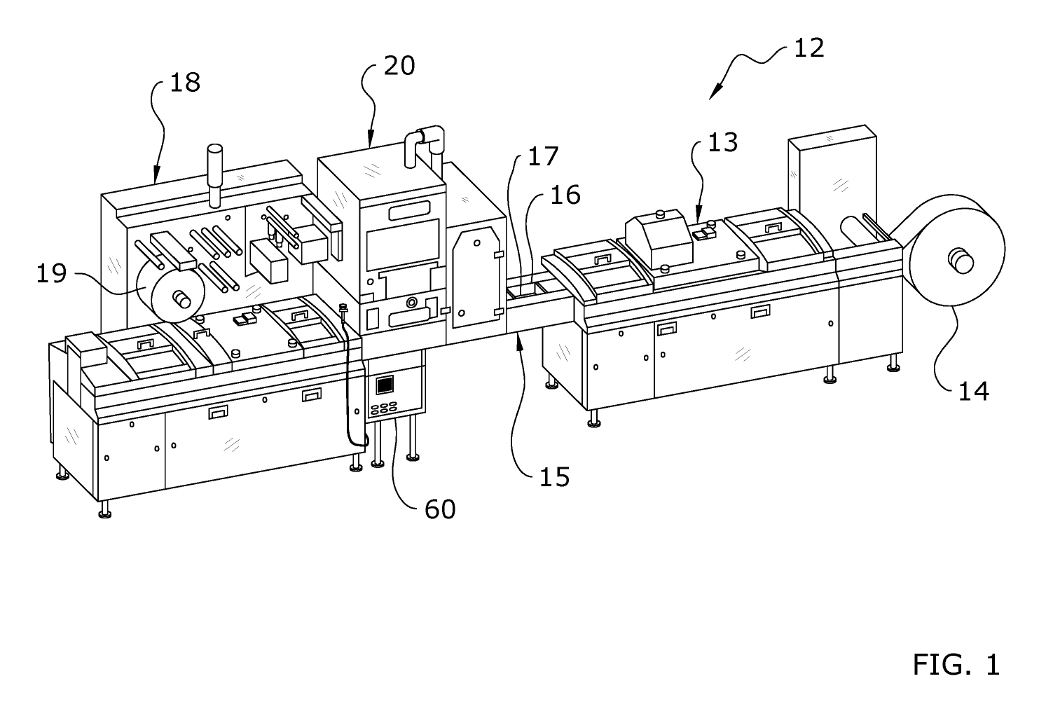

FIG. 1 illustrates an exemplary integrated packaging and printing system 12 which utilizes the methods and systems described herein. More specifically, FIG. 1 illustrates an integrated system which is capable of forming product packaging 11 and loading products into the product packaging 11. A container forming module 13 is adapted to form the product packaging 11 and a product loading module 15 is adapted to load each product packaging 11 with a product.

The integrated packaging and printing system 12 shown in FIG. 1 is also capable of printing images 74, 75 such as barcodes on the product packaging 11 with a printing module 20 and sealing the product packaging 11 with a sealing module 18. Using a computing device 60, the printing module 20 is adapted to not only print a reference image 72, but also analyze the printed images 74, 75 to detect any deformities which could impact their utility.

It should be appreciated that the configuration shown in FIG. 1 is merely exemplary. The methods and systems described herein for printing and verifying printed images 74, 75 may be utilized independently. Thus, it should not be construed that the methods and systems described herein are necessarily a part of an integrated packaging and printing system 12 as shown in the exemplary FIG. 1.

Referring to FIG. 1, an exemplary integrated packaging and printing system 12 may generally comprise a series of independent modules 13, 15, 18, 20, each carrying out a function in the packaging process and independently controlled by a computing device 60. The modules 13, 15, 18, 20 may be positioned in a series to form a path of product travel.

The integrated packaging and printing system 12 may comprise a container forming module 13, a product loading module 15, a sealing module 18, and/or a conveyor 16. Additional modules which are not shown but may be included in such an integrated packaging and printing system 12 include a separating module and a sterilization module. A sealing module 18 may also be provided for sealing a product within the product packaging 11.

The system 10 may comprise a conveyor 16 to sequentially supply a product to be wrapped in product packaging 11. The conveyor 16 may include a compartment 17 of a size to receive the bottom surface of product packaging 11 and a motor for moving the conveyor 16 and/or compartment 17 along the path of product travel. The conveyor 16 may comprise an endless belt moving at a speed under the control of the computing device 60. The belt may be driven by a motor controlled by the computing device 60. The conveyor 16 may move continuously or incrementally at spaced intervals along the length of the integrated packaging and product system 12. The speed of the conveyer 16 may relate to the product package 11 dimensions and/or product packaging rate.

The exemplary integrated packaging and product system 12 shown in FIG. 1 may include a lower web supply roll 14 disposed at one end of the system 12. The lower web may comprise a thermoformable and heat sealable packaging material or a pressure-sensitive material. The lower web supply roll 14 may be rotatably mounted on an axle disposed in a horizontal plane. The lower web may be indexed off the lower web supply roll 14 in a container forming direction.

The exemplary integrated packaging and printing system 12 shown in FIG. 1 may include a container forming module 13 to form a product container such as product packaging 11. The product packaging 11 may include sidewalls, a bottom, and a flat outwardly projecting rim. The container forming module 13 may include a plurality of molds generally in the shape of the product packaging 11.

A heating element may be positioned above the molds and overlaying the lower web, which is indexed by the conveyor 16 into the container forming module 13. The mold may be defined by a container forming die which underlies a heating element and the lower web. A duct may be disposed within the forming die to connect the mold to a vacuum system.

The vacuum system may generate negative pressure, thereby removing air from the mold, and/or may generate positive pressure, thereby filling the mold with pressurized air. The container forming die may be raised under the heating element thereby creating a seal between the heating element, the lower web, and the die. Pressurized air or other gas may be forced into the die through the duct by the vacuum system causing the lower web to contact the heating element. Once the lower web has been heated to become sufficiently formable, vacuum may be applied to the die through the duct causing the lower web to be drawn into the mold wherein the lower web is conformed into the shape of the mold. The die may then lower from the heating element and the formed containers may be indexed by the conveyor to the product loading module.

The exemplary integrated packaging and printing system 12 shown in FIG. 1 may comprise one or more preformed containers stored in a magazine (not shown) above the conveyor 16. The preformed containers may be dispensed, either individually or in multi-container units, onto the conveyor 16 in response to the computing device 60. Once dispensed onto the conveyor 16, the containers may be indexed by the conveyor 16 to the product loading module 15.

The product to be wrapped may be introduced into the container at the product loading module 15. The product may be loaded manually or mechanically.

The sealing module 18 may include a packaging material conveyance module to convey a packaging material, such as an upper web supply roll 19, for example. The web dispensed from the upper web supply roll 19 may comprise a thermoformable and heat sealable packaging material or a pressure-sensitive material. The upper web supply roll 19 may be rotatably mounted on an axle disposed in a horizontal plane. The upper web may be indexed off the upper web supply roll 19 in a package forming direction. The sealing module 18 may seal one container and/or product packaging 11 or may simultaneously seal a plurality of containers and/or product packaging 11.

The sealing module 18 may include a sealing die underlying a thermosealing element and the upper web. The die may include a duct connected to the vacuum system or, a second vacuum system (not shown). The sealing die may be raised to the thermosealing element thereby creating a seal between the sealing die, the upper web, and the thermosealing element. In the closed position, an evacuation chamber may be formed by the sealing die.

The vacuum system, or second vacuum system, may be activated to evacuate air from the chamber through evacuation ducts, thereby creating negative pressure within the chamber. When the desired degree of evacuation is reached, the thermosealing element may be lowered onto the upper web depressing it onto the rims of the container. The thermosealing element may hermetically seal the upper web to the rims. When the seal is complete, the thermosealing element may be raised from the sealed container and the sealing die may be vented through the evacuation ducts. The sealing die may then be lowered. The sealed container may be advanced by the conveyor 16 to the separating module (not shown).

The sealing module 18 may comprise an integrity detector (not shown) to detect any defects in the sealed package, such as a hole or not achieving the specified range of vacuum.

A cutter blade and an anvil may be included to separate the sealed container and upper web. When two or more containers are sealed simultaneously, the separating module may separate the sealed containers into individual sealed containers.

The exemplary integrated packaging and printing system 12 shown in FIG. 1 may comprise a sterilization module to achieve GAMMA and/or EBEAM sterilization. The sterilization module may expose the sealed container to EBEAM or gamma radiation, with single or multiple doses of radiation ranging from 5 kGy to 100 kGy.

### C. Printing Module

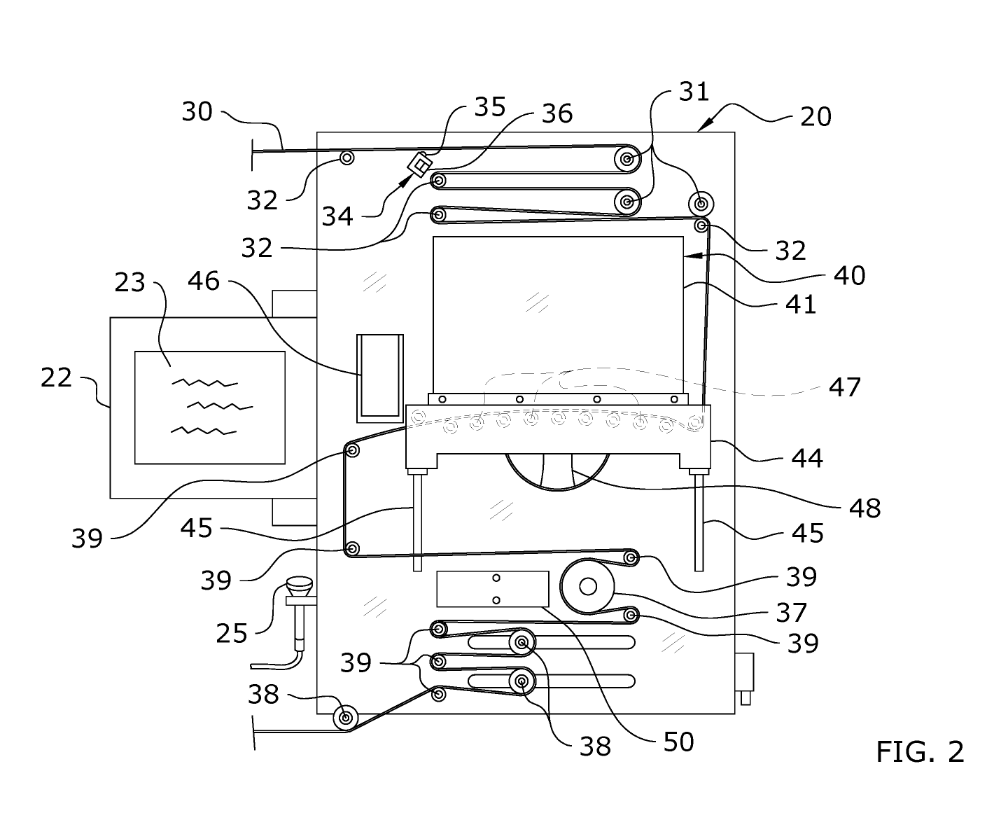

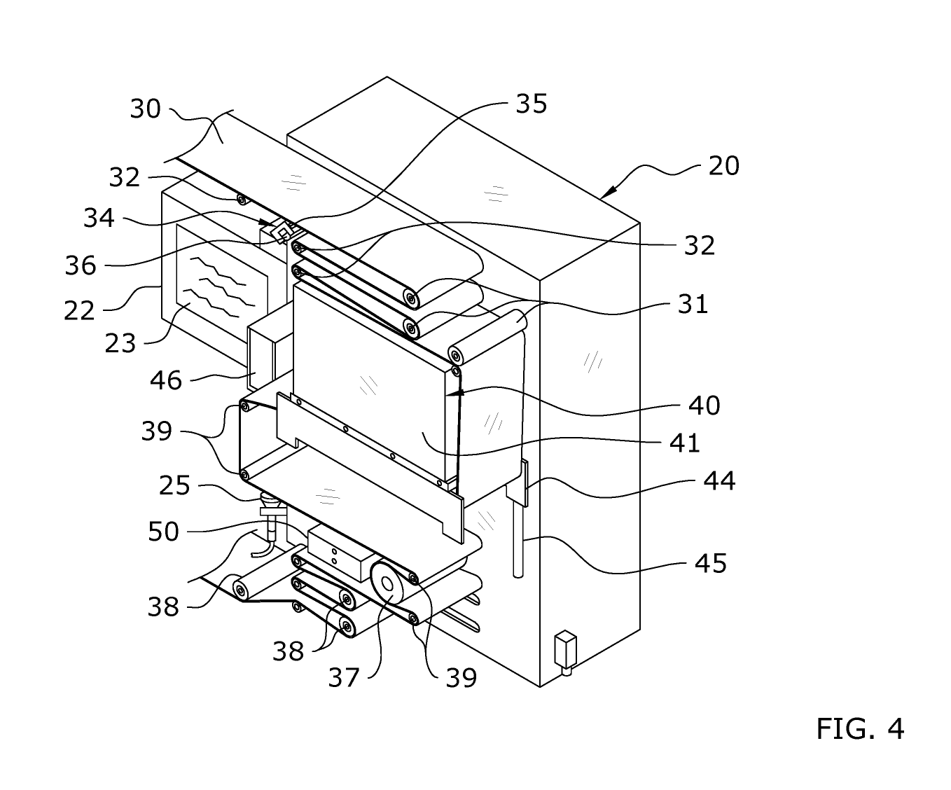

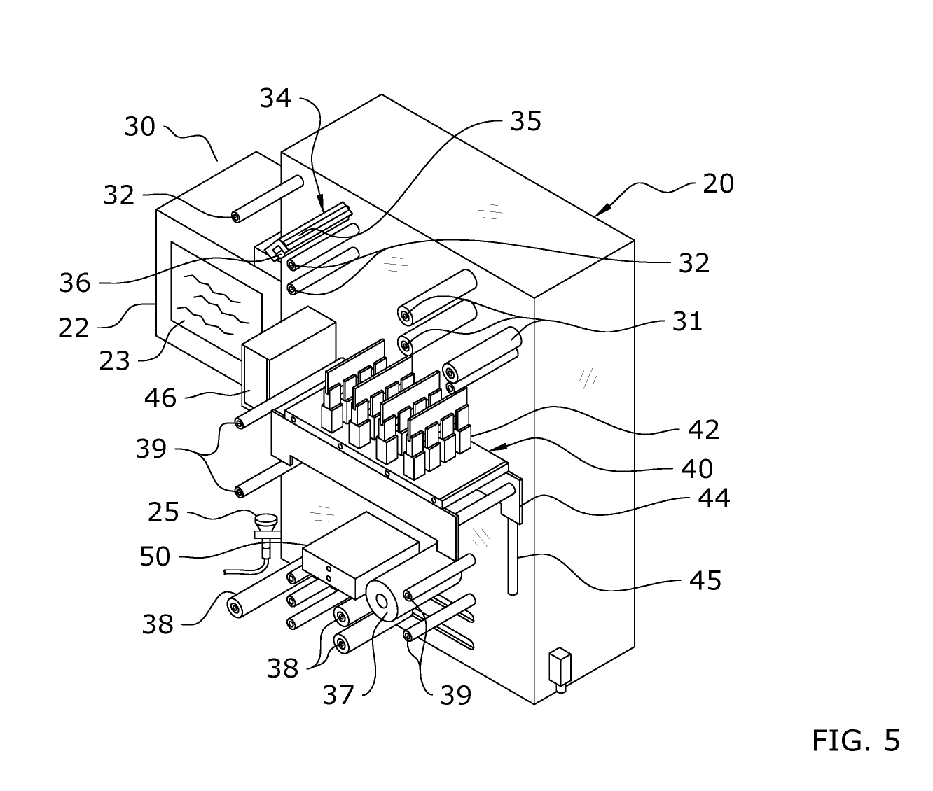

As shown in FIGS. 2-5, a printing module 20 is provided to print machine-readable codes 72 on a printing medium 30. The printing medium 30 may be the product packaging 11 itself, or may be affixed to the product packaging 11 such as by sealing, adhering, or other methods. It should be appreciated that the printing module 20 may operate completely independently of the exemplary integrated packaging and printing system 12 described in the preceding section. Alternatively, the printing module 20 may form a part of a larger system which forms an assembly line for product packaging 11.

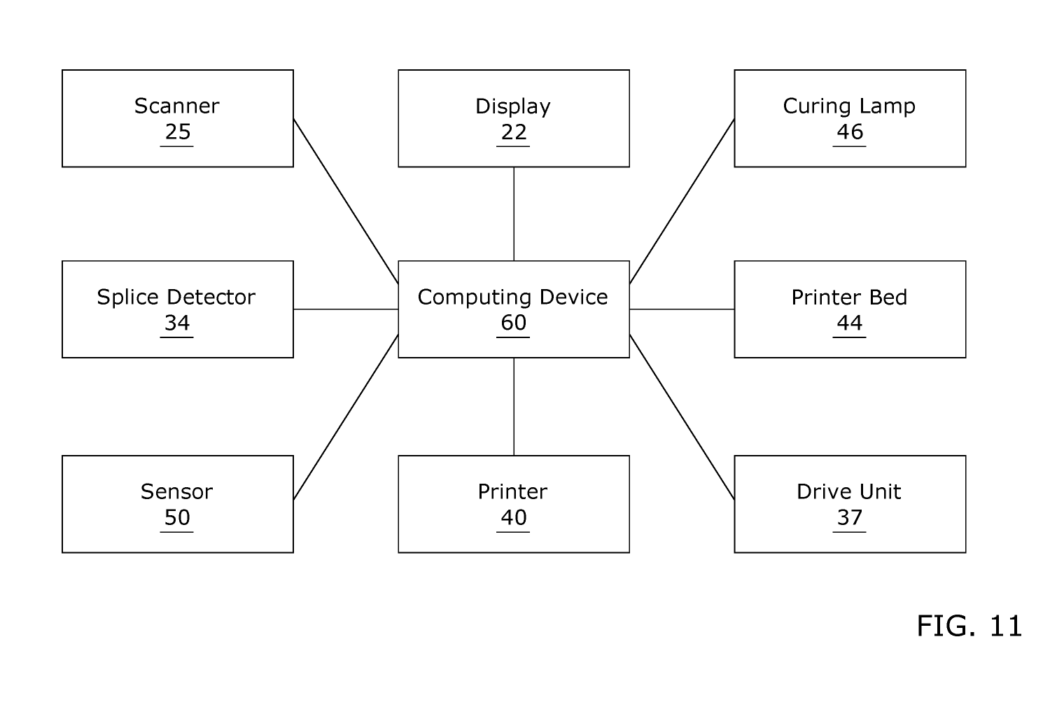

FIG. 11 is an exemplary block diagram illustrating interconnection of the various components of the printing module 20. As shown, the computing device 60 is communicatively interconnected with the display 22, the scanner 25, the splice detector 34, the printer 40, the printer bed 44, the curing lamp 46, the drive unit 37, and the sensor 50. The computing device 60 may be directly connected to any or all of these components, or may be remotely connected such as via a network.

FIGS. 2-5 shows an exemplary printing module 20 generally comprising a plurality of buffers 31, 38 and rollers 32, 39 to convey a printing medium 30 such as a roll of web paper; a scanner 25 to scan a reference image 72 to generate a reference image dataset to be printed on an object such as product packaging 11; a computing device 60 to receive the reference image dataset; a printer 40 to print a printed machine-readable code 74, 75 based on the reference image dataset on the printing medium 30; and a sensor 50 to scan the printed image 74, 75, and generate a printed image dataset. The computing device 60 analyzes the printed image dataset to identify one or more defects based on the reference image dataset. An optional sealing module 18 may apply at least one seal to a package thereby forming a sealed product packaging 11. The system may comprise a labeling module to apply the printed image 74, 75 to the sealed package. The various modules may be controlled by one or more computing devices 60.

The system may receive product data to be printed on a label, and print an image on the label based on the product data. Product data may include machine-readable code data. The product data may be sent to the printing module 20, for example, through a network interface and/or user interface. As shown in the figures, the product data may be sent to the printer 40 through an attached reader, e.g., a scanner 25 attached to the printing module 20.

In a standalone system or where there is no scanner 25 available in the printing module 20, a separate scanner (such as on a separate device) may be used. Examples of product data include codes, texts, symbols, and/or pictures. The machine-readable code may comprise a one-dimensional or two-dimensional barcode in compliance with ISO standards. The barcode may comprise a numeric-only barcode or an alpha-numeric barcode. The machine-readable code may also comprise a quick response code (QR code).

The product data in digital form, i.e., a data file, may be accepted, stored, produced, decomposed or otherwise presented at a computing device 60 of the printing module 20. The computing device 60, operating in conjunction with a memory, may provide operating control of the printing module 20. Typically, the computing device 60 is an external device, such as a computer or a server, which interfaces with a network to accept image content and process the image content for a printer 40. However, the computing device 60 may be part of the printing module 20 itself such as shown in FIG. 1. The computing device 60 receives product data that is to be printed on a label in any one of a number of possible formats, such as, for example, TIFF, JPEG, or ADOBE PostScript′. The image data may be “interpreted” or “decomposed” in a known manner into a format usable by the print module 20.

FIGS. 2-4 illustrate the printing module 20 including a sensor 50 and display 22 for displaying a user interface 23. The printing module 20 may comprise a printer 40, for example, an inkjet printer or laser printer, to sequentially print a plurality of images on a printing medium 30. The printer 40 may comprise a high-speed line printer that prints one-sided or two-sided onto a long continuous sheet of the printing medium 30. The printing module 20 may comprise a plurality of buffers 31, 38 and rollers 32, 39 for conveying the printing medium 30.

The printing module 20 may hold a roll of the printing medium 30 wound in a rolled state, and supply the continuous sheet of the printing medium 30 to the printer 40 while pulling the sheet from the roll. The printing module 20 may comprise a drive unit 37 to pull the sheet from the roll. The drive unit 37 may comprise a driven shaft which is vulcanized and driven by a motor such as a direct drive rotary servo motor. Using the motor, the drive unit 37 drives the printing medium 30 through the printer 40 at a constant speed and keeps track of the location of each print. The printing module 20 may comprise a plurality of buffers 31, 38 and rollers 32, 39 forming a conveyance path for the printing medium 30.

The configuration and orientation of the system used to convey the printing medium 30 may vary in different embodiments. An exemplary embodiment is shown in FIGS. 2-4, which should not be construed as limiting on the scope of the present invention. In such an exemplary embodiment, a plurality of upper buffers 31 and upper rollers 32 are positioned above the printer 40 to feed the printing medium 30 into the printer 40. A plurality of lower buffers 38 and lower rollers 39 are positioned beneath the printer 40 to guide the printing medium 30 out of the printer 40 after the printed image 74, 75 has been printed on the printing medium 30.

The printing medium 30 may comprise the upper web supply roll 19, e.g., a thermoformable and heat sealable packaging material or a pressure-sensitive material. The printing medium 30 may comprise paper, a transparent film, or a color film. The printing medium 30 may comprise a continuous sheet that may be longer than the length of a unit of print, e.g., a label, which is to be repeated in the direction of the printing medium conveyance path.

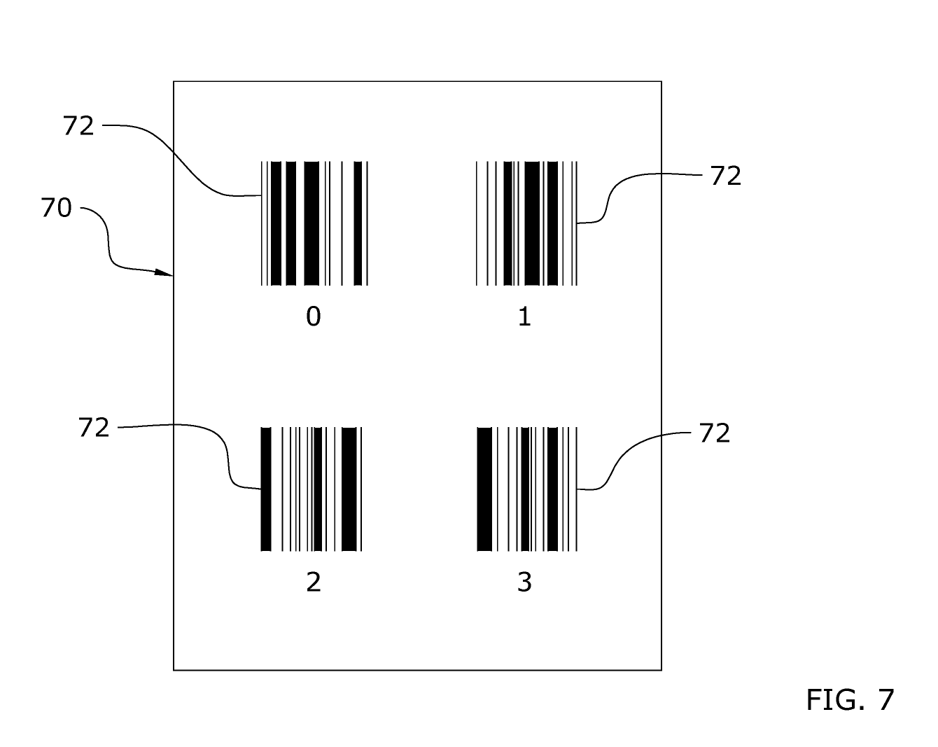

The continuous sheet of the printing medium 30 may comprise one or more splices 78 (connected portions) taped or glued at random positions, such as shown in FIG. 7. The splice 78 may be formed on the continuous sheet of the printing medium 30 at the time the roll is manufactured. A user may connect a first sheet to a second sheet to form a new continuous sheet, and in such a case, a splice 78 is formed in the middle of the continuous sheet.

At a position near the upper buffers 31, a splice detector 34 for optically detecting the splice 78 of the continuous sheet of printing medium 30, in a noncontact manner, from above the sheet surface may be provided. The splice detector 34 includes a light emitting unit 35 for emitting light on the sheet surface from a slanted direction, and an array sensor 36 for detecting the reflected light. Using the difference in the reflectivity, the splice detector 34 detects the passage of the splice 78 over the detection position of the splice detector 34.

The printer 40 may include a plurality of print heads 42. The print heads 42 may be covered by a printer housing 41 which may be removed for servicing. The ink of each color may be supplied from an individual ink tank via an ink tube to each print head 42. The ink tube may be connected to each of the print heads 42, and ink may be supplied from the ink tank (not illustrated). The number of colors and the number of heads are not limited to what is shown in the figures, but more or fewer colors and/or print heads 42 may be used. The ink may comprise a UV curable ink. The ink tank may comprise an RFID, and the printing module 20 may comprise an RFID detector to detect the RFID associated with the ink tank. Each print head 42 may be integrated with the ink tank storing the ink of the corresponding color to form a unit. The print heads 42 may be integrally held by a head holder. The head holder may be moved in a horizontal direction relative to the printing medium 30 by a drive mechanism.

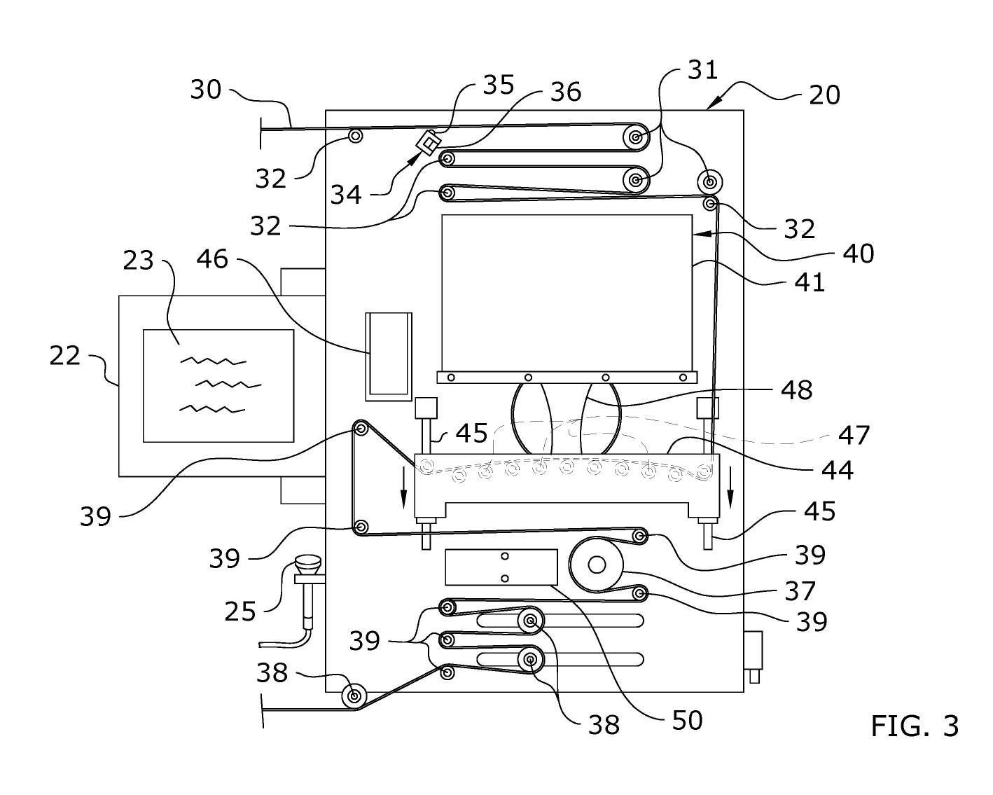

The printing medium 30 will generally pass across a printer bed 44 as the image is being printed on the printing medium 30 by the printer 40. The printer bed 44 may include its own bed rollers 47 across which the printing medium 30 will be conveyed, such as by the drive unit 37. The printer bed 44 may be stationary, or may be movable between a printing position, in which the printer bed 44 is raised as shown in FIG. 2, and a resting position, in which the printer bed 44 is lowered as shown in FIG. 3.

When the printer bed 44 is in its raised position as shown in FIG. 2, the print heads 42 will print the image onto the printing medium 30. The printer bed 44 may be adjusted between its raised and lowered positions along bed guides 45 comprising rails, slots, or other guide members which will guide movement of the printer bed 44 between its positions. An actuator 48 may be utilized to physically move the printer bed 44 between positions along the bed guides 45.

The printing module 20 may comprise a curing lamp 46 to emit ultraviolet (UV) light to cure the ink. The curing lamp 46 may generate a sufficient amount of heat during the printing and curing process. The intensity of the curing lamp may be adjustable. After the ink is cured, the printing medium 30 may be routed around the drive unit 37, and the printed image may be inspected by the sensor 50 as it passes through the lower buffers and rollers 38, 39.

The printing module 20 may comprise a service station (not shown) to service, e.g., clean, the print heads 42. A print head 42 may periodically park at the service station so that viscous plugs of ink may be cleared. Such servicing typically is directed at predetermined intervals, but may be directed upon identifying an error which may be corrected by servicing the print head 42.

When original information is received, the printing medium 30 enters the printing module 20 via an inlet and advances along a printing medium conveyance path defined by the upper buffers and rollers 31, 32 to a print zone, and a plurality of images, such as product data or machine-readable codes, may be sequentially printed on the printing medium 30. The printing module 20 may comprise feed motors (not shown) to feed the printing medium 30 through the print zone so that an image may be printed thereon. The image may comprise the product data, such as a machine-readable code, for example. The image may comprise a defect label (such as the printed term “DEFECT”) when the integrity detector of the sealing module 18 detects a hole in the sealed product packaging 11.

The printing module 20 may comprise a sensor 50 to provide feedback to the computing device 60. The sensor 50 may comprise an image sensor to periodically or continuously and automatically scan the printed image on the label. The sensor 50 may be disposed downstream from the printer 40 and placed just after the printer 40 where the ink is transferred to the printing medium 30.

As the printing medium 30 continuously advances along the printing medium conveyance path defined by the buffers 31, 38 and rollers 32, 39, the sensor 50 may scan the printed image at the same time. The sensor 50 may send the scanned information to the computing device 60. The sensor 50 may be placed to sense the printed label directly as the printed label comes out of the printer 40. The sensor 50 may comprise optical densitometers, calorimeters, electrostatic voltmeters, etc. It should be appreciated that any number of sensors 50 may be provided, and may be placed anywhere in the printing module 20 as needed, and not just in the locations illustrated in the exemplary figures.

The sensor 50 may comprise a linear array sensor or a full width array (FWA) sensor, for example, to scan the printed image as the printing medium 30 moves past the sensor 50. A full width array sensor comprises a sensor 50 that extends substantially an entire width (perpendicular to a direction of motion) of the moving printed image (e.g., the printed label). The full width array sensor may detect any desired part of the printed image. The full width array sensor may include a plurality of sensors 50. It is understood that other linear array sensors may also be used, such as contact image sensors, charge coupled device (CCD) image sensors, or complementary metal-oxide semiconductor (CMOS) image sensors, for example. The linear sensor array may be much more sensitive than the human eye and may discern non-uniformities and defects before a person (e.g., a quality control technician) may be capable of doing so.

The system may comprise a labeling module to apply the printed image 74, 75 to the sealed package. At a position downstream of the sensor 50, lower buffers and rollers 38, 39 may discharge the printing medium 30 from a feed slot beneath the printing module 20. An output web buffer may move the printing medium 30 toward the packaged product on the conveyer 16 with the adhesive side facing downward toward the packaged product.

The labeling module may comprise an actuator. When applying the printing medium 30 to product packaging 11, an actuator moves the printing medium 30 toward the product packaging 11 until contact is established. The actuator presses the adhesive side of the printing medium 30 with sufficient force to adhesively bond the label to the product packaging 11.

### D. Computing Device

Aspects of the present invention may also be realized by a computing device 60 of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computing device 60 for example via a network or from a recording medium of various types serving as the memory device (e.g., computer-readable medium). An apparatus may be implemented within, include, or otherwise be connected to a central processing unit (CPU), where the CPU is connected to a memory and executes a variety of functions by executing a variety of application programs that are stored in the memory, such as a read only memory (ROM). The ROM may store such information as an operating system, various applications, a control program, and data. The operating system may be the software that controls the allocation and usage of hardware resources such as memory, central processing unit, disk space, and peripheral devices. A random access memory (RAM) may temporarily store the program or the data that is loaded from the ROM. The RAM also is used as a space wherein the CPU executes the variety of programs. In an example, a computer-readable storage medium may store a program that causes a printing apparatus to perform a method described herein. In another example, a central processing unit (CPU) may be configured to control at least one unit utilized in a method or apparatus described herein.

The printing module 20 may comprise a computing device 60 to analyze the scanned printed image and identify one or more defects or non-conformities. The computing device 60 may characterize defects in terms of quantitative parameters and/or qualitative parameters. The computing device 60 may include an image processor to conduct image analysis of the scanned printed image to identify defects and/or non-conformities.

The computing device 60 may analyze the scanned printed image using image analysis or processing techniques or pattern recognition, for example, to evaluate image quality and/or identify defects. The image processor may determine a match between the printed image and the original product data, a test image, or a second printed image. The computing device 60 may acquire input image data from the scanner 25 and provide output image data to an output destination and/or a printer 40. The computing device 60 may send an error message to the display 22 to be displayed when the computing device 60 detects one or more defects.

A single computing device 60 may be utilized or, in some embodiments, multiple computing devices 60 may work together or in tandem to perform the various functionalities described herein. Although the figures illustrate a single computing device 60 handling all of the functionalities described, this should not be construed as limiting on the scope of the present invention.

### E. Operation of Preferred Embodiment

A method of printing may generally comprise conveying a printing medium 30; receiving a reference image 72 to be applied to the printing medium 30; printing the image based on the reference image 72 on the printing medium 30; scanning the printed image 74, 75 on the printing medium 30 and acquiring a printed image dataset; and analyzing the printed image dataset to identify one or more defects based on the reference image 72. The method may comprise labeling a sealed package with the printed image.

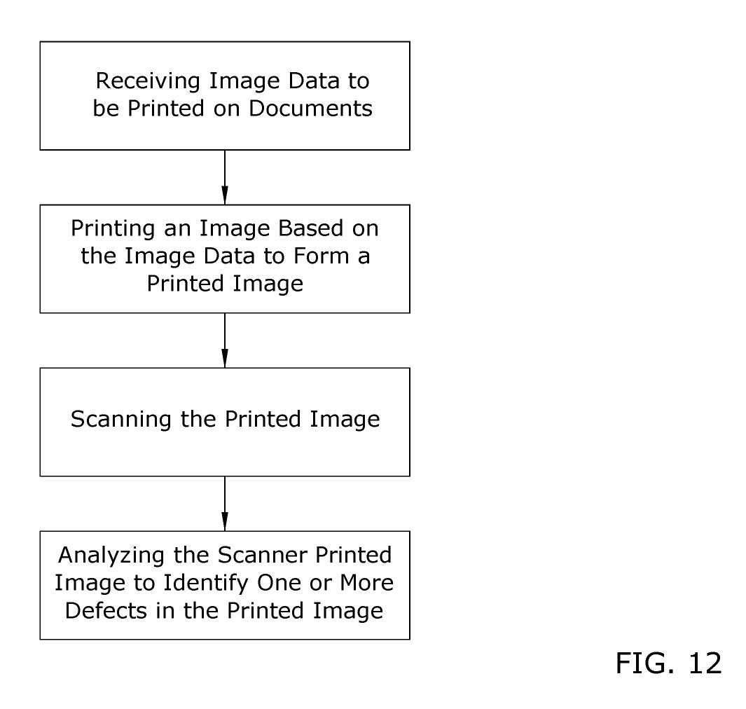

As shown in FIG. 12, an image to be printed on a label may be received by the system, such as by scanning a reference image sheet 70 containing a plurality of reference images 72. The reference image 72 may be received by the scanner 25 and communicated to the computing device 60. The product data may be stored on the computing device 60. The reference image 72 such as a machine-readable code may be applied to the printing medium 30 based on the image data received by the computing device 60 to form a printed image 74, 75.

The image may be applied to the printing medium using a printer 40. The printed image 74, 75 may be scanned using a sensor 50 such as a full-width linear array sensor. The scanned printed image may be analyzed by the computing device 60 to identify one or more defects in the printed image 74, 75 and thus differentiate between a defective printed image 74 and a correct printed image 75.

In the case of a machine-readable code, the printed machine-readable code 74, 75 may be independently verified before the product packaging 11 is sealed and/or after the printed machine-readable code 74, 75 is applied to the sealed product packaging 11. The scanned printed image may be applied to a sealed product packaging 11 by a labeling module. The package may be sealed by the sealing module 18 as described above. The method may comprise transferring the sealed product packaging 11 with a defective machine-readable code 74 including the one or more defects to a reject bin.

The method may comprise receiving a product to be sealed, such as medical items, for example, transferring the product onto a conveyor 16 that defines a path of product travel, applying a product packaging 11 to the product moving along the path of product travel, and sealing product packaging 11 moving along the path of product travel to form the sealed package. The method may comprise labeling the sealed package moving along the path of product travel. The product packaging 11 material may comprise the printing medium 30. The method may comprise forming a product container and loading the product into the product container as discussed above.

Turning to a more descriptive exemplary method of printing an image on an object, a reference image 72 is first saved to the computing device 60. The reference image 72 may be transferred to the computing device 60 via various methods. As an example relating to machine-readable codes, a reference image sheet 70 may be provided which includes a plurality of reference machine-readable codes 72. Alternatively, the reference image 72 could be provided to the computing device 60 via usage of various storage mediums, such as a USB drive or the like, or via a network such as the Internet.

An exemplary reference image sheet 70 is shown in FIG. 7. This is merely an exemplary view, and it should be appreciated that reference image sheets 70 may include any number of reference images 72 and may also include other printed text, such as identifying each of the reference images 72.

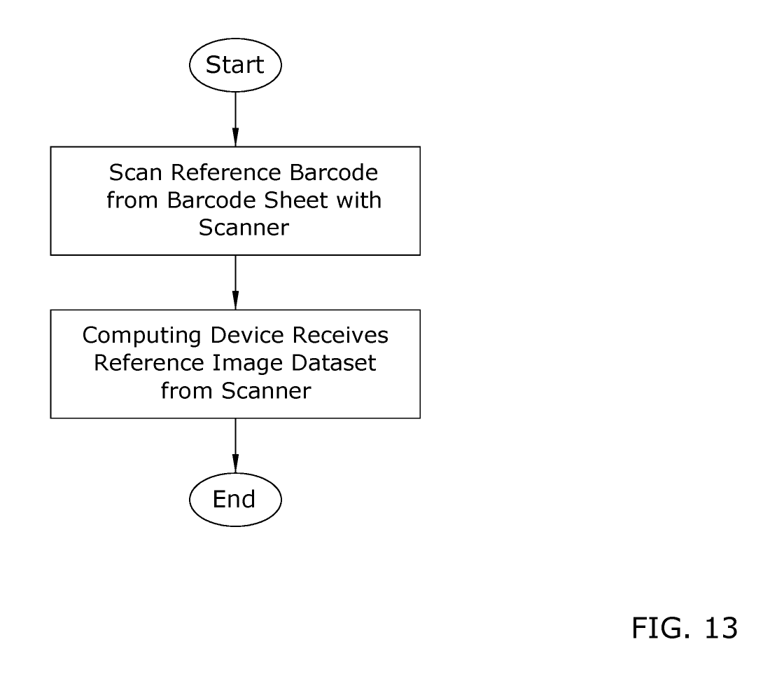

Using the example of labeling a product, upon receiving a product to be labeled, the user may first access the reference image sheet 70 and scan the requisite reference image 72 for that particular product as shown in FIG. 13. For example, the machine-readable code sheet 70 may include a plurality of reference machine-readable codes 72; each being associated with a different medical product. The user would position a scanner 25 near the reference miage sheet 70 and scan the reference machine-readable code 72 which relates to the particular product being packaged. This reference machine-readable code 72 is transferred to the computing device 60 as a reference image dataset and retained by the computing device 60 so that it may be compared to the printed image dataset.

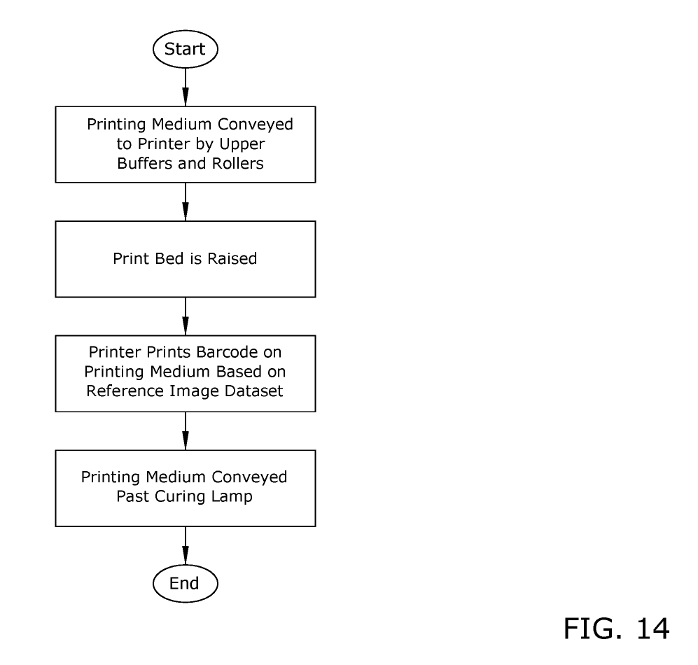

FIG. 14 illustrates an exemplary method of printing the image 74, 75. To print the image 74, 75 on the printing medium 30, the printing medium 30 is first routed through the upper buffers and rollers 31, 32, and past the splice detector 34. If a splice 78 is detected, the printer 40 will stop printing after completing the print it is on and move the printing medium 30 away from the print heads 42, such as by lowering the printer bed 44. The splice 78 may be moved through the printer 40, with the printer bed 44 not being raised up again until the splice 78 has exited the printer 40.

As shown in FIG. 8, after passing through the upper buffers and rollers 31, 32, and assuming any splices 78 have been passed through the printer 40, the print bed 44 is raised by the actuator 48 along the bed guides 45 so that the print heads 42 may print the reference image on the printing medium 30. Once the printing medium 30 is past the print heads 42 it passes under a curing lamp 46 to be cured. The curing lamp 46 is only turned on when the printing medium 30 is being printed on and the printing medium 30 is moving forward.

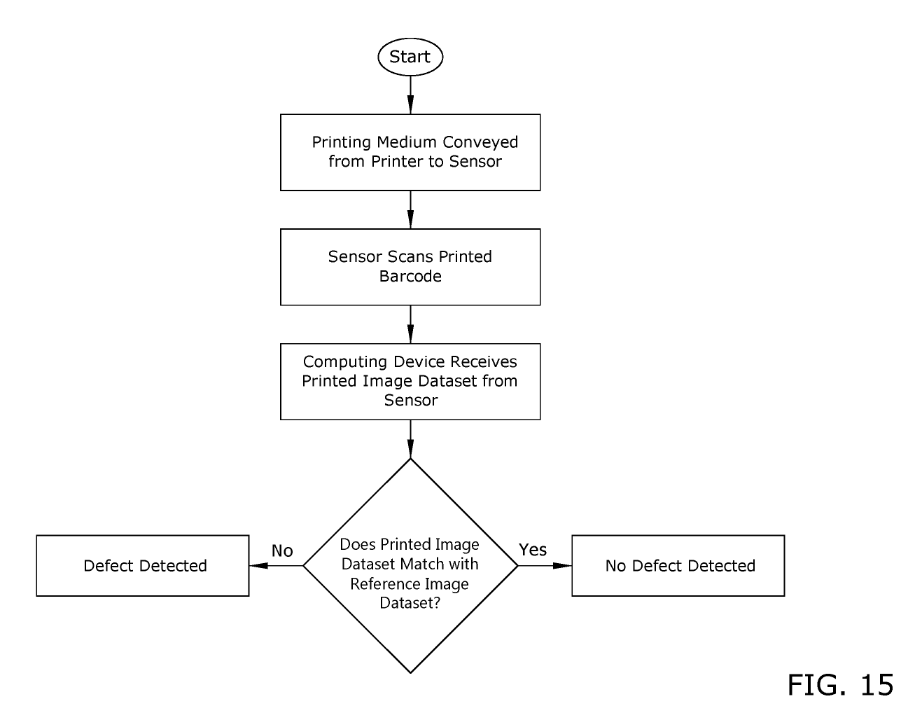

After being cured, the printing medium 30 passes through the lower buffers and rollers 38, 39. As the printing medium 30 with the printed image passes the drive unit 37, the printed image is scanned by the sensor 50. FIG. 15 illustrates an exemplary method of verifying accuracy of the printed image. The scanned printed image by the sensor 50 is used to create a scanned image dataset. This scanned image dataset is compared by the computing device 60 with the reference image dataset. Alternatively, the computing device 60 may directly compare the printed image 74, 75 with the reference image 72. In either case, if the datasets or images do not match, the computing device 60 will detect a defect.

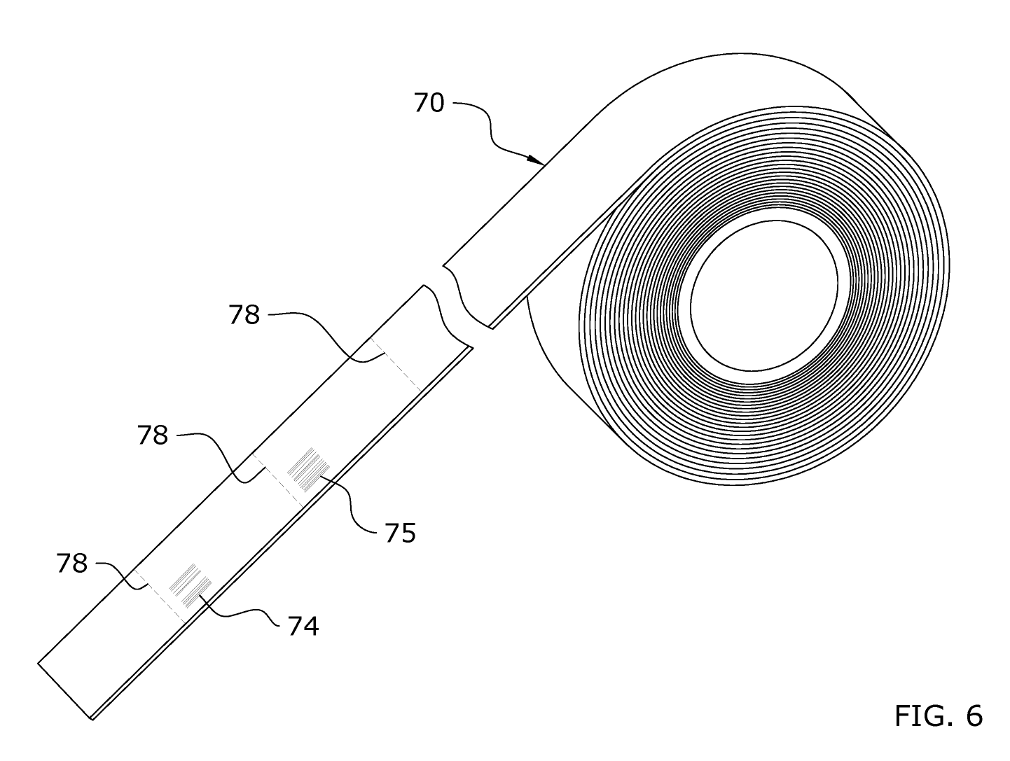

Various types of defects may be detected, such as misaligned lines, missing lines, faded ink, and other types of defects which could be caused by any number of factors, such as printer misalignment, running out of ink, or improper conveyer speed. FIG. 6 illustrates a printing medium 30 showing a defective image 74 and a correct image 75. FIG. 8 shows product packaging 11 showing a defective image 74 and a correct image 75.

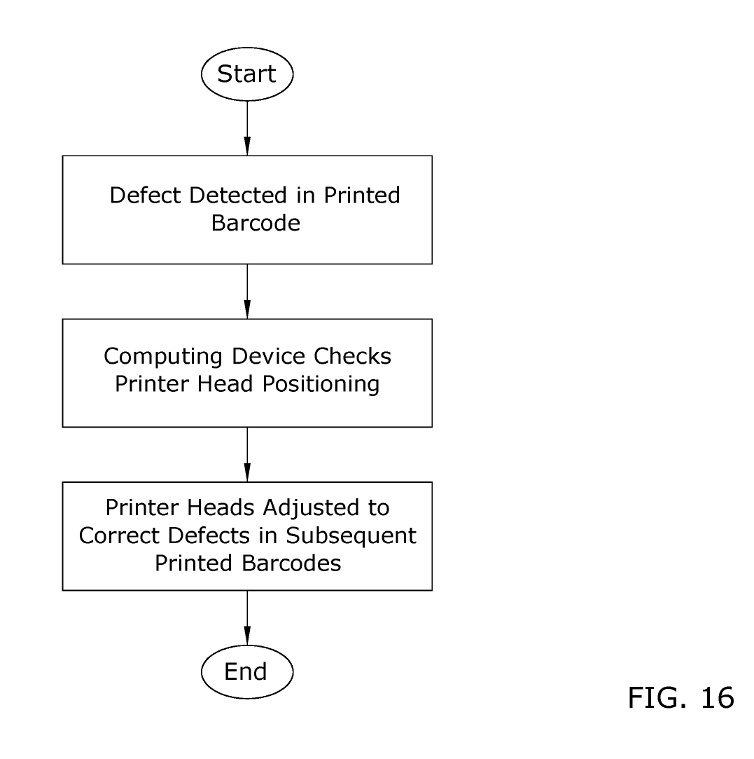

FIG. 16 illustrates an exemplary method of correcting misalignment of print heads 42 in the printer 40. If a defect is detected that represents misalignment of print heads 42, the computing device 60 may check the print head 42 alignment and adjust accordingly to prevent defects in each subsequent printing. For example, the computing device 60 may adjust when the print heads 42 fire in order for the image to be stitched together properly without defects. This alignment check may be performed each time an image is printed, or may be performed once at start-up of the system.

If defects are detected, the printing medium 30 on which the defective image 74 is printed may be rejected, such as by a thermoformer. If there are two defective prints in a row, a warning may be issued via the display 22. The system may be shut down until the cause of the defect (i.e., misalignment, ink reservoirs, conveyer speed) has been corrected. Future prints will similarly be verified to ensure full accuracy of the system.

Unless otherwise defined, all technical and scientific terms used herein have the same meaning as commonly understood by one of ordinary skill in the art to which this invention belongs. Although methods and materials similar to or equivalent to those described herein can be used in the practice or testing of the printer system, suitable methods and materials are described above. All publications, patent applications, patents, and other references mentioned herein are incorporated by reference in their entirety to the extent allowed by applicable law and regulations. The printer system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A printing system, comprising:
a printing medium;
a computing device adapted to receive a reference image to be printed on the printing medium;
a printer for printing a printed image on the printing medium based on the reference image; and
a sensor adapted to scan the printed image, wherein the computing device is adapted to analyze the printed image scanned by the sensor to identify one or more defects in the printed image on the printing medium.

2. The printing system of claim 1, further comprising a scanner for scanning the reference image to be printed on the printing medium;

3. The printing system of claim 1, further comprising a display adapted to display an error message when the computing device detects the one or more defects.

4. The printing system of claim 1, wherein the sensor comprises a contact image sensor.

5. The printing system of claim 1, wherein the computing device is adapted to compare the reference image with the printed image to identify the one or more defects.

6. The printing system of claim 1, wherein the printed image comprises a machine-readable code.

7. The printing system of claim 6, wherein the machine-readable code comprises a barcode.

8. The printing system of claim 1, wherein the printing medium comprises web paper, wherein the web paper includes a plurality of splices.

9. The printing system of claim 8, further comprising a splice detector for detecting the splices.

10. The printing system of claim 1, further comprising a curing lamp for curing the printed image on the printing medium.

11. A method of printing an image on an object, comprising:
conveying a printing medium;
receiving a reference image to be printed on the object by a computing device;
printing a printed image on the object by a printer based on the reference image;
scanning the printed image on the printing medium by a sensor; and
analyzing the printed image by the computing device to identify one or more defects based on the reference image.

12. The method of claim 11, wherein the printer comprises a plurality of printer heads.

13. The method of claim 12, further comprising the step of automatically adjusting positioning of the plurality of printer heads if the one or more defects are detected by the computing device to correct the one or more defects.

14. The method of claim 11, wherein the sensor comprises a contact image sensor.

15. The method of claim 11, further comprising the step of comparing the reference image with the printed image by the computing device to identify the one or more defects.

16. The method of claim 11, wherein the image comprises a machine-readable code.

17. The method of claim 16, wherein the object comprises a product packaging.

18. The method of claim 11, wherein the printing medium comprises web paper, wherein the web paper includes a plurality of splices.

19. The method of claim 18, further the step of detecting the splices by a splice detector.

20. The method of claim 11, further comprising the step of curing the printed image on the printing medium with a curing lamp.
